(19) United States
(12) Patent Application Publication
(10) Pub. No.: US 2010/0206386 A1
(43) Pub. Date: Aug. 19, 2010

(54) APPARATUS AND METHOD FOR AUTOMATICALLY DISABLING UTILITIES

(75) Inventor: Kevin M. Crucs, Copley, OH (US)

Correspondence Address: HAHN LOESER & PARKS, LLP, One GOJO Plaza, Suite 300, AKRON, OH, 44311-1076, US

(73) Assignee: CRUCS HOLDINGS, LLC, Copley, OH (US)

(21) Appl. No.: 12/388,637

(22) Filed: Feb. 19, 2009

(51) Int. Cl. F15C 3/00; F16K 31/12

(52) U.S. Cl. 137/2; 137/486

(57) ABSTRACT

A safety apparatus and method for automatically disabling a utility of a facility. One safety apparatus may be connected, for example, in a basement of a house in line with a water pipe just after a water meter. Another safety apparatus may be connected, for example, in an apartment building in line with a gas utility pipe just after a gas meter. Still another safety apparatus may be connected, for example, in a house in line with a home heating oil pipe. Any of the safety apparatuses include means for measuring a rate of flow of a fluid from a utility fluid source, means for determining if the measured rate of flow indicates the existence of an abnormal flow condition, and means for disabling the flow of fluid from the utility fluid source if the abnormal flow condition is determined to exist.

### TECHNICAL FIELD

Certain embodiments of the present invention relate to shutting off utilities. More particularly, certain embodiments relate to automatically disabling a utility to a facility in response to a sensed abnormal condition.

### BACKGROUND

An existing problem in the area of utilities providing natural gas or water to a facility is that, if a leak or break were to occur in a utility pipe within the facility, no practical means or method may be provided for terminating the water or natural gas flowing into the facility unless one is physically present at the time that the leak occurs. The consequences of this problem are well known to, for example, the home owner or tenant who has experienced a burst hot water tank, a broken water pipe, or a leaky natural gas pipe or valve.

Further limitations and disadvantages of conventional, traditional, and proposed approaches will become apparent to one of skill in the art, through comparison of such approaches with the subject matter of the present application as set forth in the remainder of the present application with reference to the drawings.

### SUMMARY

An embodiment of the present invention comprises a safety apparatus for automatically disabling a utility of a facility. The apparatus includes a fluid valve device capable of being set to at least an open state and a closed state. The apparatus also includes a flow rate sensor device operatively connected to the fluid valve device and capable of sensing a flow rate of a fluid flowing through the apparatus and capable of outputting a signal or data representative of the sensed flow rate. The apparatus further includes an electronic controller device operatively connected to the flow rate sensor device to receive the signal or data representative of the sensed flow rate, and operatively connected to the fluid valve device and capable of commanding the fluid valve device to the closed state if the electronic controller device determines an abnormal flow condition based on the signal or data representative of the sensed flow rate.

The apparatus further includes a fluid input port capable of channeling a fluid into the apparatus and a fluid output port capable of channeling the fluid out of the apparatus. The apparatus may also include a user interface device capable of being actuated by a user to reset the fluid valve device to the open state from the closed state. The apparatus may be adapted to accommodate a fluid including a gas, a fluid including water, or a fluid including oil.

The apparatus may further include a user interface device capable of being actuated by a user to activate the apparatus to sense a flow rate, determine an abnormal flow condition based on the flow rate, and set the fluid valve device to the closed state in response to the determined abnormal flow condition. The apparatus may further include a visible indicator capable of indicating to a user when the apparatus is activated. The user interface device may also be capable of again being actuated by the user to deactivate the apparatus such that a fluid is able to flow freely through the apparatus without being disrupted by the apparatus.

Another embodiment of the present invention comprises a method for automatically disabling a utility of a facility. The method includes measuring a rate of flow of a fluid from a utility fluid source and determining if the measured flow rate indicates the existence of an abnormal flow condition. The method also includes disabling the flow of fluid from the utility fluid source if the abnormal flow condition is determined to exist. The facility may be a residential house, an apartment, or an office building, for example. An abnormal flow condition may be determined to exist if the measured rate of flow is greater than a predefined flow rate threshold for longer than a predefined period of time. As an alternative, an abnormal flow condition may be determined to exist if the measured rate of flow is substantially constant and non-zero for longer than a predefined period of time.

A further embodiment of the present invention comprises a safety apparatus for automatically disabling a utility of a facility. The apparatus includes means for measuring a rate of flow of a fluid from a utility fluid source and means for determining if the measured rate of flow indicates the existence of an abnormal flow condition. The apparatus also includes means for disabling the flow of fluid from the utility fluid source if the abnormal flow condition is determined to exist. The utility fluid source may be a source of a gas into the facility, a source of water into the facility, or a source of oil into the facility, for example. The apparatus may further include a user interface device allowing a user to set the predefined flow rate threshold and/or the predefined period of time, for example. The apparatus may also include means for monitoring and tracking actual utility usage during a learning mode and determining expected usage and setting flow thresholds and/or time periods based on the expected usage. The apparatus may further include means for the apparatus to automatically activate at certain times and to automatically de-activate at certain other times. The apparatus may also include means for the apparatus to communicate with a motion sensor system or with a security system.

These and other novel features of the subject matter of the present application, as well as details of illustrated embodiments thereof, will be more fully understood from the following description and drawings.

### BRIEF DESCRIPTION OF THE DRAWINGS

FIG. 1 illustrates a schematic diagram of an example configuration using a utility safety apparatus in a facility, in accordance with an embodiment of the present invention;

FIG. 2 illustrates a first example embodiment of a safety apparatus for automatically disabling a utility into a facility and which may be used in the configuration of FIG. 1;

FIG. 3 illustrates a second example embodiment of a safety apparatus for automatically disabling a utility into a facility and which may be used in the configuration of FIG. 1; and

FIG. 4 is a flow chart of an example embodiment of a method for automatically disabling a utility into a facility using the safety apparatus of FIG. 2 or FIG. 3 in, for example, the configuration of FIG. 1.

### DETAILED DESCRIPTION

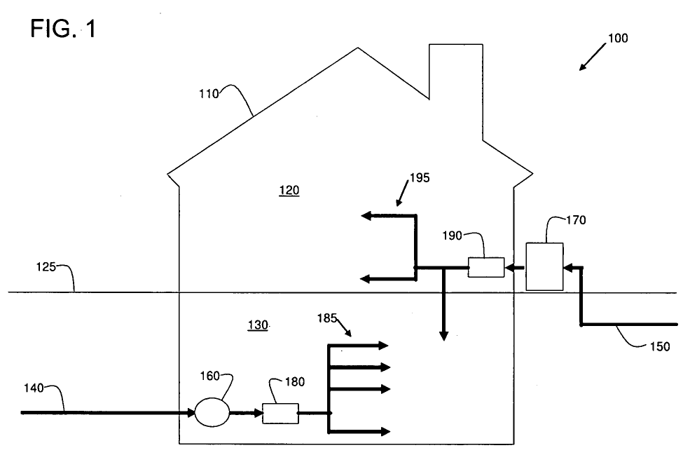

FIG. 1 illustrates a schematic diagram of an example configuration 100 using a utility safety apparatus in a facility 110, in accordance with an embodiment of the present invention. The facility 110 is a residential house having an area 120 being above the ground level 125 and a basement area 130 being below the ground level 125. The house 110 has utilities running to it including water and natural gas from a source of water 140 and a source of natural gas 150, respectively. In accordance with other configurations, the facility may be an apartment or an office building. Other types of facilities are possible as well.

The source of water 140 enters the basement area 130 and comes into a traditional water meter 160. The source of natural gas 150 comes into a traditional gas meter 170 and then enters the area 120 from an output of the gas meter 170. Traditionally, water pipes or conduits would be used to distribute water throughout the house 110. Similarly, gas pipes or conduits would be used to distribute natural gas throughout the house 110. However, in accordance with an embodiment of the present invention, a water safety apparatus 180 is connected at the output of the water meter 160 before the water is routed through pipes 185 throughout the house 110. Similarly, in accordance with an embodiment of the present invention, a gas safety apparatus 190 is connected at the output of the gas meter 170 before the gas is routed through pipes 195 throughout the house 110.

The water safety apparatus 180 functions to monitor a flow rate (e.g., in units of milliliters per second) of water into the house and detect abnormal flow conditions. Similarly, the gas safety apparatus 190 functions to monitor flow rate (e.g., in units of cubic centimeters per second) of natural gas into the house and detect abnormal flow conditions. If an abnormal flow condition is detected by the water safety apparatus 180, the water safety apparatus 180 disables the flow of water into the house. Similarly, if an abnormal flow condition is detected by the gas safety apparatus 190, the gas safety apparatus 190 disables the flow of natural gas into the house. In general, an abnormal flow condition is a flow condition that is unexpected.

For example, if a family that lives in the house 110 goes away on vacation for a week, the water safety apparatus 180 and the gas safety apparatus 190 may be activated. The water safety apparatus 180 is adapted to determine that an abnormal flow condition exists if, for example, a measured rate of flow (e.g., in ml/sec) through the apparatus 180 is substantially constant and non-zero for longer than a predefined period of time. Such an abnormal condition may be indicative of a water leak or burst water pipe somewhere within the house 110 since no one should be in the house 110 using water for such a predefined period of time. Other criterion may be used to determine an abnormal flow condition, in accordance with alternative embodiments of the present invention. For example, the water safety apparatus 180 may be adapted to determine that an abnormal flow condition exists if a measured rate of flow through the apparatus 180 simply exceeds a predefined flow rate.

Similarly, the gas safety apparatus 190 is adapted to determine that an abnormal flow condition exists if a measured rate of flow through the apparatus 190 is greater than a predefined flow rate threshold for longer than a predefined period of time. Such an abnormal condition may be indicative of a gas leak or broken gas pipe somewhere within the house 110. Such a flow of gas above the minimal needs for a gas water heater and pilot lights may indeed be indicative of a gas leak, for example. Other criterion may be used to determine an abnormal flow condition, in accordance with alternative embodiments of the present invention. For example, the gas safety apparatus 190 may be adapted to determine that an abnormal flow condition exists if a measured rate of flow through the apparatus 190 simply exceeds a predefined flow rate.

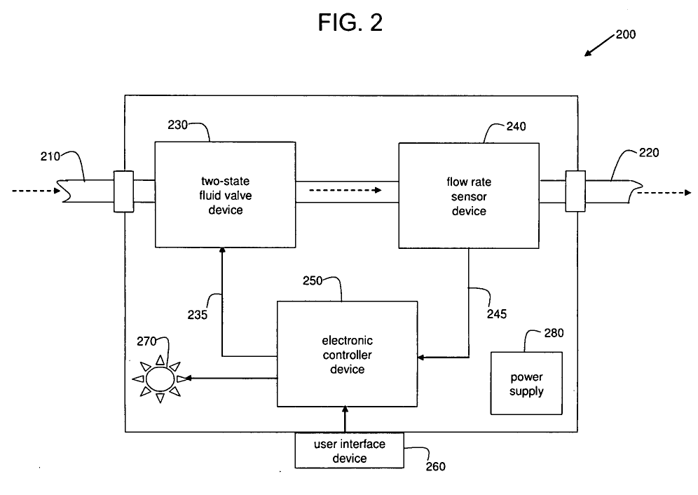

FIG. 2 illustrates a first example embodiment of a safety apparatus 200 for automatically disabling a utility into a facility and which may be used in the configuration 100 of FIG. 1. The safety apparatus 200 includes a fluid input port 210 capable of channeling a fluid into the apparatus 200, and a fluid output port 220 capable of channeling fluid out of the apparatus 200. The apparatus 200 may be adapted to accommodate a fluid such as, for example, natural gas, propane, home heating oil, or water. For example, in the configuration 100 of FIG. 1, the fluid input port 210 may be connected to the output of the water meter 160 (or gas meter 170), and the fluid output port 220 may be connected to the internal piping 185 (or 195) before branching and distributing occurs. Thus, the apparatus 200 is connected in-line with the utility coming into the facility.

The safety apparatus 200 also includes a fluid valve device 230 capable of being set at least to an open state allowing a fluid to flow through the apparatus 200 from the input port 210 to the output port 220, and a closed state preventing a fluid from flowing through the apparatus 200. Other intermediate fluid flow states may be possible as well, in accordance with other embodiments of the present invention. The safety apparatus 200 further includes a flow rate sensor device 240 operatively connected to the fluid valve device 230. The flow rate sensor device 240 is capable of sensing a flow rate of a fluid flowing through the apparatus 200, and is capable of outputting a signal or data representative of the sensed flow rate. In the apparatus 200 of FIG. 2, fluid (e.g., water or natural gas) flows into the input port 210 and then into the fluid valve device 230, then from the fluid valve device 230 (if the fluid valve device 230 is in an open state) into the flow rate sensor device 240, then out of the flow rate sensor device 240 and through the output port 220.

The safety apparatus 200 further includes an electronic controller device 250. The electronic controller device 250 is operatively connected to the flow rate sensor device 240 and the fluid valve device 230. The electronic controller device 250 is capable of receiving the signal or data representative of the sensed flow rate from the flow rate sensor device 240 via the electronic path 245. Furthermore, the electronic controller device 250 is capable of commanding the fluid valve device 230 to the closed state (non-flowing state) if the electronic controller device 250 determines the existence of an abnormal flow condition based on the signal or data representative of the sensed flow rate. Again, such an abnormal flow condition may be, for example, a substantially constant flow of gas above the minimal needs for a gas water heater and pilot lights which may be indicative of a gas leak.

In accordance with an embodiment of the present invention, the electronic controller device 250 is a microprocessor-based device that is capable of being programmed (e.g., via software instructions) to perform certain functions as described herein. In accordance with an alternative embodiment of the present invention, the electronic controller device 250 is a discrete component device that is adapted to perform certain functions as described herein. For example, the electronic control device 250 may include an electronically programmable read only memory (EPROM) component that is used as a look-up-table (LUT) to map input flow rates, received from the flow rate sensor 240 via the electronic path 245, to output command signals, sent to the fluid valve device 230 via the electronic path 235.

In accordance with an embodiment of the present invention, the two-state fluid valve device 230 has an electromagnet inside which causes the device 230 to close when a small charge or voltage Vᵥₐₗᵤₑ is applied at the electromagnet. In such an embodiment, the two-state fluid valve device 230 would open when the voltage Vᵥₐₗᵤₑ is not present at the electromagnet. The voltage Vᵥₐₗᵥₑ causes the two-state fluid valve 230 to transition from an open (flowing) state to a closed (non-flowing) state, preventing fluid from the utility source from passing through the safety apparatus 200 and on to the distributive piping or conduit of the facility. Such valve devices are well known in the art. The electronic controller device 250 is capable of providing the voltage Vᵥₐₗᵥₑ to the two-state fluid valve device 230 via the electronic path 235.

Other types of charge or voltage controlled valve devices may be possible as well. In accordance with an alternative embodiment of the present invention, the valve device 230 may operate in an opposite manner. That is, the two-state fluid valve device 230 may open when a small charge or voltage Vᵥₐₗᵥₑ is applied at the electromagnet. In such an alternative embodiment, the two-state fluid valve device 230 would close when the voltage Vᵥₐₗᵥₑ is not present at the electromagnet.

In accordance with certain embodiments of the present invention, the flow rate sensor device 240 outputs one of an analog voltage level signal indicative of the flow rate through the flow rate sensor 240, an analog square wave signal whose frequency varies linearly with flow rate through the flow rate sensor 240, and a digital data signal encoding data indicative of the flow rate through the flow rate sensor 240. Such flow rate sensors are well known in the art. Other types of signals or data indicative of flow rate may be possible as well, in accordance with various other embodiments of the present invention.

The safety apparatus 200 may also include a user interface device 260 operatively connected to the electronic controller device 250. The user interface device 260 may be capable of being actuated by a user to reset the fluid valve device 230 to the open state from the closed state via the electronic controller device 250. Also, the user interface device 260 may be capable of being actuated by a user to activate (i.e., turn on) the apparatus 200 such that the apparatus may perform the various functions described herein. Similarly, the user interface device 260 may be further capable of again being actuated by a user to deactivate the apparatus 200 such that a fluid is able to flow freely through the apparatus 200 without being disrupted by the apparatus 200, almost as if the apparatus 200 were not present in the utility line.

Furthermore, the user interface device 260 may be used to select or enter a mode or a predefined flow rate (e.g., a flow rate threshold) and/or a predefined period of time (e.g., a time interval) defining an abnormal flow condition. The user interface device 260 is located on an external portion of the apparatus 200 such that the user interface device 260 may be easily accessible by a user.

The apparatus 200 may also include a visible indicator 270 (e.g., a light emitting diode, LED) capable of indicating to a user when the apparatus is activated (i.e., turned on). The visible indicator 270 could be part of (or indicated on a display of) the user interface device 260, in accordance with an alternative embodiment of the present invention. Similarly, the apparatus 200 may further include a second visible indicator (not shown) capable of indicating to a user when the apparatus 200 is in the closed state or when the apparatus is in the open state.

Certain devices of the safety apparatus 200 may require electric power to be applied in order to function. For example, the electronic controller device 250, the flow rate sensor device 240, the user interface device 260, and the visible indicator device 270 may each require direct current (DC) electrical power to be applied (e.g., 5 VDC or 12 VDC). Therefore, the apparatus 200 includes a power source 280.

In accordance with an embodiment of the present invention, the power source 280 may include one or more batteries along with other circuitry for forming the direct current (DC) voltages with respect to a ground potential GND. In accordance with another embodiment of the present invention, the power source 280 may include a power regulator/converter that takes in alternating current (AC) from, for example, a standard 110 VAC power source and converts the AC voltage to DC voltages. Such power sources are well known in the art.

In accordance with an embodiment of the present invention, the various devices 250, 260, 270, and 280 may be mounted on a printed circuit board (PCB) which provides the various electrical interfaces between the devices. The PCB with the mounted devices, the two-state fluid valve device 230, and the flow rate sensor device 240 may be mounted substantially internally to the safety device 200 within a housing of the safety device 200.

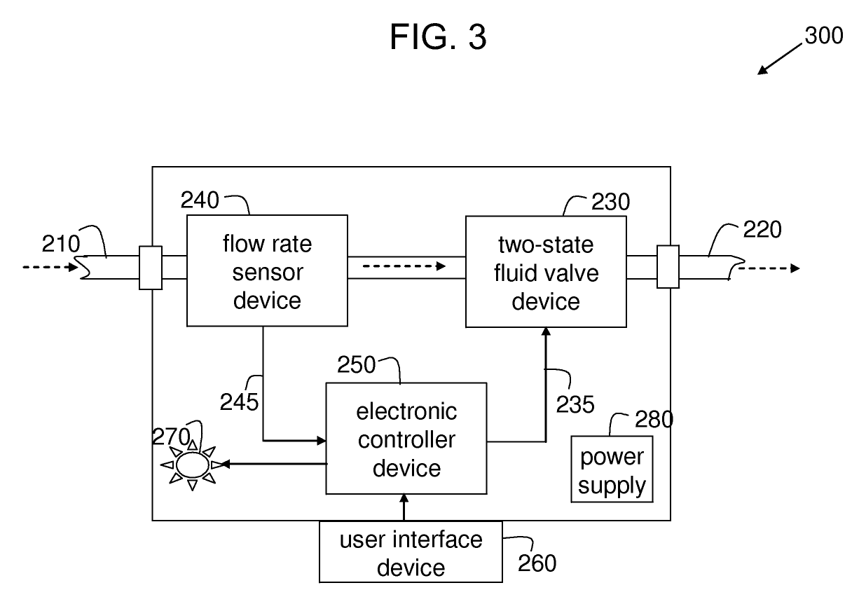

FIG. 3 illustrates a second example embodiment of a safety apparatus 300 for automatically disabling a utility into a facility and which may be used in the configuration 100 of FIG. 1. The safety apparatus 300 of FIG. 3 is very similar to and functions very similar to the safety apparatus 200 of FIG. 2, except that the safety apparatus 300 of FIG. 3 has the flow rate sensor device 240 upstream of the two-state fluid valve device 230.

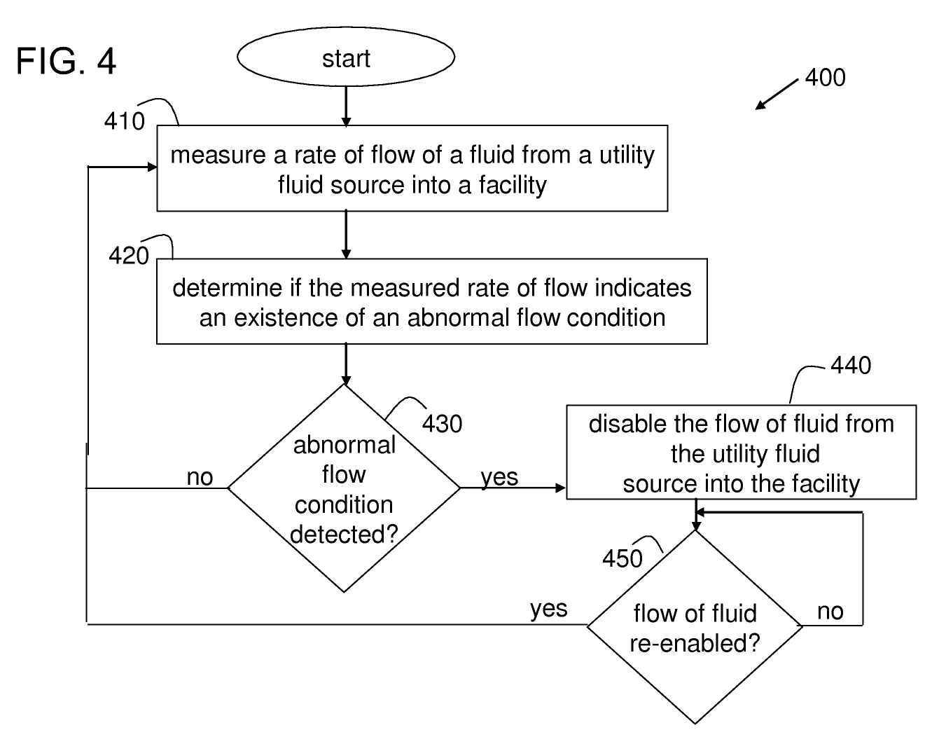

FIG. 4 is a flow chart of an example embodiment of a method 400 for automatically disabling a utility coming into a facility 110 using the safety apparatus 200 of FIG. 2 or the safety apparatus 300 of FIG. 3 in, for example, the configuration 100 of FIG. 1. In step 410, measure a rate of flow of a fluid from a utility fluid source into a facility. In step 420, determine if the measured rate of flow indicates the existence of an abnormal flow condition. In step 430, if an abnormal flow condition has been detected then, in step 440, disable the flow of fluid from the utility fluid source into the facility, otherwise, go back to step 410 and continue the method 400. If the flow of fluid from the utility fluid source into the facility has been disabled in step 440 then, in step 450, check if the flow of fluid has been re-enabled (e.g., by a user resetting a safety apparatus). If the flow of fluid has been re-enabled in step 450, then go back to step 410 and continue the method 400. Otherwise, keep checking, in step 450, if the flow of fluid has been re-enabled.

As an example, referring to FIG. 1, a family living in a residential house decides to go on vacation for a week. Before leaving, a member of the family (i.e. a user) activates a water safety apparatus 180 connected at an output of a water meter 160 in the basement 130 of the house 110, and activates another natural gas safety apparatus 190 connected at an output of a natural gas meter 170 leading into the house 110. The water safety apparatus 180 is set by the user to a “vacation” mode via a user interface 260 of the water safety apparatus 180. Similarly, the natural gas safety apparatus 190 is set by the user to a “vacation” mode via a user interface 260 of the natural gas safety apparatus 190.

For the “vacation” mode of the water safety apparatus 180, an assumption is made that almost no water should be drawn by any portion of the house 110 while the family is away on vacation and, therefore, any flow rate measured by the water safety apparatus 180 should be zero or at least very nearly zero (e.g., there may be some small amounts of water that are occasionally drawn for relatively short periods of time due to certain appliances in the house 110 such as an ice maker within a freezer).

When the “vacation” mode of the water safety apparatus 180 is selected by the user, a flow rate threshold is set within the water safety apparatus 180 to a relatively low level. Furthermore, a period of time or time interval is set within the water safety apparatus. If a leak occurs in a water pipe 185 or a water pipe 185 should break or burst while the family is away on vacation, then the rate of flow of water detected by the water safety apparatus 180 should rise above the set flow rate threshold and remain above the set flow rate threshold for at least the set period of time (i.e., an abnormal flow condition exists). The water safety apparatus 180 constantly or periodically compares the measured flow rate to the set flow rate threshold and keeps track of the time interval over which the threshold is exceeded. As a result, after the set period of time has elapsed with the detected rate of flow being above the set flow rate threshold, the water safety apparatus 180 will automatically disable itself (i.e. close a water valve) preventing additional water from being supplied to the house 110 as described herein.

Similarly, for the “vacation” mode of the natural gas safety apparatus 190, an assumption is made that a minimal amount of natural gas will be drawn by any portion of the house 110 while the family is away on vacation and, therefore, any flow rate measured by the natural gas safety apparatus 190 should be below some known level (e.g., there may be some small amount of natural gas that is constantly drawn due to minimal needs for a gas water heater and various other pilot lights).

When the “vacation” mode of the natural gas safety apparatus 190 is selected by the user, a flow rate threshold is set within the natural gas safety apparatus 190 to a relatively low level. If a leak occurs in a natural gas pipe 195 or appliance while the family is away on vacation, then the rate of flow of natural gas detected by the natural gas safety apparatus 190 should rise above the set flow rate threshold (i.e., an abnormal flow condition exists). The natural gas safety apparatus 190 constantly or periodically compares the measured flow rate to the set flow rate threshold to determine if the threshold is exceeded. As a result, with the detected rate of flow being above the set flow rate threshold, the natural gas safety apparatus 190 will automatically disable itself (i.e. close a gas valve) preventing additional natural gas from being supplied to the house 110 as described herein.

The process of comparing measured flow rates to a threshold and/or keeping track of the measured flow rate level over a time interval is accomplished by the electronic controller device 250 as described herein. The electronic controller device 250 may be a programmable microprocessor-based controller device or, for example, a discrete component controller device. The electronic controller device 250 outputs a disabling signal (e.g., a voltage level) to the fluid valve device 230 when an abnormal flow condition is detected.

When the family returns from vacation, if, for example, a water leak or a gas leak has occurred, a user will have to re-enable the appropriate disabled safety apparatus to allow water and/or natural gas to again flow into the house. Preferably, the safety apparatus is not re-enabled by a user until the problem (e.g., leak or busted pipe) has been fixed. However, the user may re-enable the safety apparatus, at least for a short period of time, in order to find the source of the problem. The safety apparatus may include a “trouble-shooting” mode, allowing a user (e.g., a plumber) to track down a leak, for example.

When the family is at home using the various appliances and water outlets of the house under normal living conditions, the safety apparatus may not be activated. That is, the safety apparatus may be turned off, allowing water and natural gas to flow into the house almost as if the safety apparatuses were not in line with the utilities. Alternatively, the safety apparatuses may be placed in an “at home” mode, where the safety apparatuses are activated and the various thresholds and/or time intervals are set to account for normal usage of water and natural gas such that the safety apparatuses are not disabled during normal usage of the utilities.

For example, the safety apparatuses may be capable of being trained during a “learning” mode by monitoring and tracking actual utility usage and determining normal or average behavior (i.e., expected usage) during a learning period. Various thresholds and/or time intervals are automatically set based on usage information acquired during the “learning” mode. Afterwards, when the safety appartuses are placed in an “at home” mode, normal usage will not disable the safety apparatuses by closing the valves within the safety apparatuses. However, any significant deviation from normal usage, as defined by the various set thresholds and/or time intervals, will disable the safety apparatuses by closing the valves.

An example of a significant deviation from normal usage might be when a child accidentally leaves an outside water faucet on after watering a garden with a hose connected to the outside water faucet. The water safety apparatus would be able to detect this abnormal water usage and close the water valve within the water safety apparatus.

Furthermore, the safety apparatus may keep track of actual time-of-day which may also be used to determine whether valves should be closed or not. For example, normal usage during the middle of the day may be very different from normal usage during the middle of the night. Therefore, one set of thresholds and/or time intervals may be used by the safety apparatuses during the middle of the day, and another set may be used during the middle of the night. As an alternative, a safety apparatus may be set to be activated only during certain hours of the day and de-activated at certain other hours of the day. For example, a user may only desire to have the safety apparatuses activated at night when the user is sleeping (e.g., between 11:00 p.m. and 6:00 a.m.). Such activation and de-activation occurs automatically after a user sets the activated time interval via a user interface of the safety apparatus.

Other activation/de-activation periods may be set as well. For example, a user may know that his lawn sprinkler system is on every morning between 4:00 a.m. and 5:00 a.m. and, therefore, programs the water safety apparatus to be de-activated during this time. As another example, the safety apparatuses may also be programmed to keep track of not only the time of day, but also the date and/or the day of the week. A user may desire to have the safety apparatuses activated only on weekdays when the user is at work. As a further example, a user may desire to have the safety apparatuses activated only from January through March when the user is away at a winter home in Florida for these winter months.

In accordance with various other embodiments of the present invention, other types of abnormal flow conditions and modes of operation may be defined and programmed into or set into a safety apparatus. For example, upper and lower flow rate thresholds may be defined where a flow rate is considered abnormal if the flow rate falls outside of the range defined between the upper and lower thresholds. Other abnormal flow conditions and modes may be defined as well, in accordance with various other embodiments of the present invention.

In accordance with other embodiments of the present invention, a safety apparatus may be used elsewhere within a facility besides where a utility first comes into the facility. For example, a water safety apparatus may be installed in-line at the hot water output of a hot water tank within a house, thus protecting the house against any hot water line failures. Furthermore, a natural gas safety apparatus may be installed at a natural gas input to a gas furnace within a house, thus protecting the house from certain types of gas furnace failures. In accordance with another embodiment of the present invention, the safety apparatus may be a home heating oil safety apparatus that may be installed at a home heating oil input to an oil furnace within a house, thus protecting the house from certain types of oil furnace failures (e.g, if an old oil furnace gets stuck on for a prolonged period of time). Other installed locations within a house or other types of facilities are possible as well.

In accordance with a further alternative embodiment of the present invention, the safety apparatus may be operatively connected to a motion sensor system. The motion sensor system may send a signal to the electronic controller device of the safety apparatus where the signal indicates the presence or absence of detected motion. When the motion sensor system indicates to the safety apparatus that no one is home (i.e., no or insignificant motion is detected) and, however, there is an unexpected large flow of water detected, the valve within the water safety device may be automatically closed. The signal may be sent electronically, optically, or wirelessly, for example, from the motion sensor system to the safety apparatus using techniques that are well known in the art.

Similarly, in accordance with still a further alternative embodiment of the present invention, the safety apparatus may be operatively connected to a security system. The security system may send a signal to the electronic controller device of the safety apparatus where the signal indicates that the security system is activated (i.e., no one is home). When the security system indicates to the safety apparatus that no one is home (i.e., the security system is activated) and, however, there is an unexpected large flow of water detected, the valve within the water safety device may be closed. The signal may be sent electronically, optically, or wirelessly, for example, from the security system to the safety apparatus using techniques that are well known in the art.

In summary, a safety apparatus and method for automatically disabling a utility of a facility are disclosed. One safety apparatus may be connected, for example, in a basement of a house in line with a water pipe just after a water meter. Another safety apparatus may be connected, for example, in an apartment building in line with a gas utility pipe just after a gas meter. Still another safety apparatus may be connected, for example, in a house in line with a home heating oil pipe. Any of the safety apparatuses include means for measuring a rate of flow of a fluid from a utility fluid source, means for determining if the measured rate of flow indicates the existence of an abnormal flow condition, and means for disabling the flow of fluid from the utility fluid source if the abnormal flow condition is determined to exist.

While the claimed subject matter of the present application has been described with reference to certain embodiments, it will be understood by those skilled in the art that various changes may be made and equivalents may be substituted without departing from the scope of the claimed subject matter. In addition, many modifications may be made to adapt a particular situation or material to the teachings of the claimed subject matter without departing from its scope. Therefore, it is intended that the claimed subject matter not be limited to the particular embodiment disclosed, but that the claimed subject matter will include all embodiments falling within the scope of the appended claims.

What is claimed is:

1. A safety apparatus for automatically disabling a utility of a facility, said apparatus comprising:
a fluid valve device capable of being set to at least an open state and a closed state;
a flow rate sensor device operatively connected to said fluid valve device and capable of sensing a flow rate of a fluid flowing through said apparatus and capable of outputting a signal or data representative of said sensed flow rate; and
an electronic controller device operatively connected to said flow rate sensor device to receive said signal or data representative of said sensed flow rate, and operatively connected to said fluid valve device and capable of commanding said fluid valve device to said closed state if said electronic controller device determines an abnormal flow condition based on said signal or data representative of said sensed flow rate.

2. The apparatus of claim 1 further comprising a fluid input port capable of channeling a fluid into said apparatus.

3. The apparatus of claim 1 further comprising a fluid output port capable of channeling a fluid out of said apparatus.

4. The apparatus of claim 1 further comprising a user interface device capable of being actuated by a user to reset said fluid valve device to said open state from said closed state.

5. The apparatus of claim 1 further comprising a user interface device capable of being actuated by a user to activate said apparatus to sense a flow rate, determine an abnormal flow condition based on said flow rate, and set said fluid valve device to said closed state in response to said determined abnormal flow condition.

6. The apparatus of claim 5 wherein said user interface device is further capable of again being actuated by said user to deactivate said apparatus such that a fluid is able to flow freely through said apparatus without being disrupted by said apparatus.

7. The apparatus of claim 5 further comprising a visible indicator capable of indicating to a user when said apparatus is activated.

8. The apparatus of claim 1 wherein said apparatus is adapted to accommodate a fluid including a gas.

9. The apparatus of claim 1 wherein said apparatus is adapted to accommodate a fluid including water.

10. The apparatus of claim 1 wherein said apparatus is adapted to accommodate a fluid including oil.

11. A method for automatically disabling a utility of a facility, said method comprising:
measuring a rate of flow of a fluid from a utility fluid source;
determining if said measured rate of flow indicates an existence of an abnormal flow condition; and
disabling said flow of fluid from said utility fluid source if said abnormal flow condition is determined to exist.

12. The method of claim 11 wherein said utility fluid source comprises a source of a gas.

13. The method of claim 11 wherein said utility fluid source comprises a source of water.

14. The method of claim 11 wherein said utility fluid source comprises a source of oil.

15. The method of claim 11 wherein said facility comprises one of a residential house, an apartment, and an office building.

16. The method of claim 11 wherein said abnormal flow condition is determined to exist if said measured rate of flow is greater than a predefined flow rate threshold.

17. The method of claim 11 wherein said abnormal flow condition is determined to exist if said measured rate of flow is greater than a predefined flow rate threshold for longer than a predefined period of time.

18. The method of claim 11 wherein said abnormal flow condition is determined to exist if said measured rate of flow is substantially constant and non-zero for longer than a predefined period of time.

19. A safety apparatus for automatically disabling a utility of a facility, said apparatus comprising:
means for measuring a rate of flow of a fluid from a utility fluid source;
means for determining if said measured rate of flow indicates an existence of an abnormal flow condition; and
means for disabling said flow of fluid from said utility fluid source if said abnormal flow condition is determined to exist.

20. The apparatus of claim 19 where said utility fluid source comprises a source of a gas.

21. The apparatus of claim 19 where said utility fluid source comprises a source of water.

22. The apparatus of claim 19 where said utility fluid source comprises a source of oil.

23. The apparatus of claim 19 where said facility comprises one of a residential house, an apartment, and an office building.

24. The apparatus of claim 19 wherein said abnormal flow condition exists if said measured rate of flow of said fluid is greater than a predefined flow rate threshold.

25. The apparatus of claim 19 wherein said abnormal flow condition exists if said measured rate of flow of said fluid is greater than a predefined flow rate threshold for longer than a predefined period of time.

26. The apparatus of claim 19 wherein said abnormal flow condition exists if said measured rate of flow of said fluid is substantially constant and non-zero for longer than a predefined period of time.

27. The apparatus of claim 24 further comprising a user interface device allowing a user to set said predefined flow rate threshold.

28. The apparatus of claim 25 further comprising a user interface device allowing a user to set said predefined flow rate threshold and said predefined period of time.

29. The apparatus of claim 26 further comprising a user interface device allowing a user to set said predefined period of time.

30. The apparatus of claim 19 further comprising means for monitoring and tracking actual utility usage during a learning mode and determining expected usage and setting flow thresholds and time periods based on said expected usage.

31. The apparatus of claim 19 further comprising means for said apparatus to automatically activate at certain times and to automatically de-activate at certain other times.

32. The apparatus of claim 19 further comprising means for said apparatus to communicate with a motion sensor system.

33. The apparatus of claim 19 further comprising means for said apparatus to communicate with a security system.
